(19) United States
(12) Patent Application Publication
(10) Pub. No.: US 2025/0292602 A1
(43) Pub. Date: Sep. 18, 2025

(54) IMAGE ENCODING DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: MAKOTO KIMURA, Nisshin-shi (JP)

(21) Appl. No.: 19/013,832

(22) Filed: Jan. 8, 2025

(30) Foreign Application Priority Data
Mar. 18, 2024 (JP) 2024-041799

(51) Int. Cl. G06V 20/70; G06T 7/215; G06T 7/246; G06V 10/764; G06V 10/77; G06V 20/58

(52) U.S. Cl. CPC G06V 20/70; G06T 7/215; G06T 7/248; G06V 10/764; G06V 10/7715; G06V 20/58; G06T 2207/10016; G06T 2207/20016; G06T 2207/20021; G06T 2207/30252

(57) ABSTRACT

An image encoding device includes: an image acquisition unit that acquires a label image in which a label representing a type of a feature is assigned to a region of the label image corresponding to the feature in a label target image; a block division determination unit that determines a division pattern of an encoding target block in an encoding target image based on the region in the label image and the label assigned to the region; and an encoding unit that executes an encoding process for the encoding target block specified by the division pattern.

### CROSS REFERENCE TO RELATED APPLICATION

The present application claims the benefit of priority from Japanese Patent Application No. 2024-041799 filed on Mar. 18, 2024. The entire disclosure of the above application is incorporated herein by reference.

### TECHNICAL FIELD

The present disclosure relates to an image encoding device.

### BACKGROUND ART

Conventionally, in the encoding process of time-sequentially arranged images included in a video, for example, as defined in the international standards H.265 and H.266, each image is divided into blocks of various sizes and encoded for each block. As a method for dividing the blocks in this case, various methods have been proposed. For example, in a conceivable technique, a feature amount in an image is extracted using machine learning, and a block division pattern is determined using the feature amount. In another conceivable technique, a CNN (i.e., convolutional neural network) model is used to determine whether or not to divide an N×N block into smaller S×S blocks (here, S and N are natural numbers, and S<N). In another conceivable technique, an object is detected in an image, and the detection position of the object is subjected to frequency analysis to specify the type of the object, and a block size is determined according to the type.

### SUMMARY OF INVENTION

According to an example, an image encoding device may include: an image acquisition unit that acquires a label image in which a label representing a type of a feature is assigned to a region of the label image corresponding to the feature in a label target image; a block division determination unit that determines a division pattern of an encoding target block in an encoding target image based on the region in the label image and the label assigned to the region; and an encoding unit that executes an encoding process for the encoding target block specified by the division pattern.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a functional configuration of an image encoding device according to an embodiment of the present disclosure;

FIG. 2 is a flowchart showing a procedure of a division pattern determination process in the first embodiment;

FIG. 3 is an explanatory diagram showing an example of an encoding target image;

FIG. 4 is an explanatory diagram showing an example of the setting contents of a block size correction table;

FIG. 5 is a flowchart showing the procedure of an N×N block division determination process in the first embodiment;

FIG. 6 is an explanatory diagram showing an example of labeling without block division;

FIG. 7 is an explanatory diagram showing an example of labeling with block division;

FIG. 8 is a block diagram showing the functional configuration of an image encoding device according to a second embodiment;

FIG. 9 is a flowchart showing a procedure of a division pattern determination process in the second embodiment;

FIG. 10 is a flowchart showing a procedure of a division pattern determination process in the third embodiment; and

FIG. 11 is a block diagram showing the functional configuration of an image encoding device according to a fourth embodiment.

### DETAILED DESCRIPTION

The above-described conceivable techniques require a trained neural network to select the encoding parameters, and resources such as an NPU (i.e., Neural Network Processing Unit) to execute the trained neural network. The above-described conceivable technique also requires pre-processing for executing the frequency analysis and the resources required for the pre-processing. Therefore, in the conventional technique, there is a difficulty that determination of the encoding block causes an increase in circuit scale and an increase in cost. Therefore, a technique is desired that can properly determine the encoding block while suppressing excessive resource consumption.

According to an example of the present embodiments, an image encoding device includes: an image acquisition unit that acquires a label image in which a label representing a type of a feature (i.e., object) is assigned to an area of the label image corresponding to the feature in a labelling target image; a block division determination unit that determines a division pattern of an encoding target block in an encoding target image based on the region in the label image and the label assigned to the region; and an encoding unit that executes an encoding process for the encoding target block specified by the division pattern.

The image encoding device of the above embodiment includes a block division determination unit that determines a division pattern of an encoding target block in an encoding target image based on each region in a label image and the labels assigned to the regions. Therefore, the encoding block can be properly determined while suppressing excessive consumption of resources for determining the division pattern of the encoding target block.

### A. First Embodiment

### A1. Device Configuration:

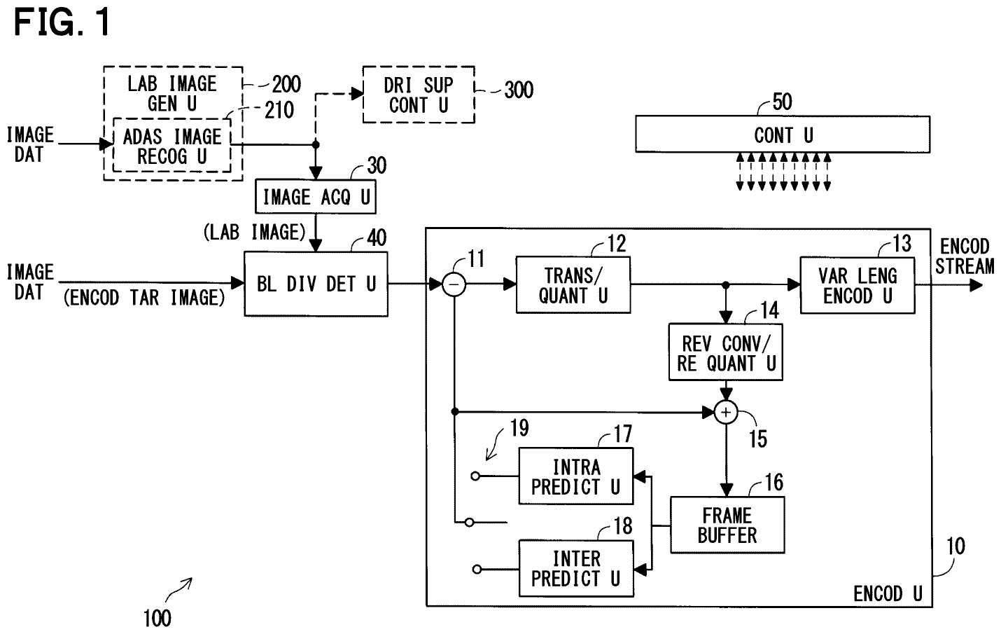

An image encoding device 100 according to the first embodiment shown in FIG. 1 encodes an image. In this embodiment, the images as a target of encoding by the image encoding device 100 are multiple images that constitute a video, and are acquired successively in time series. The image encoding device 100 is configured by a computer equipped with a CPU, a ROM, and a RAM (not shown). In this embodiment, the computer is an in-vehicle ECU (i.e., Electronic Control Unit) not shown. Here, the image encoding device 100 is not limited to an in-vehicle ECU, and may be configured by a computer built into a fixed server device or a portable device such as a smartphone or a tablet terminal.

FIG. 1 shows a functional unit of an image encoding device 100. The image encoding device 100 includes an encoding unit 10, an image acquisition unit 30, a block division determination unit 40, and a control unit 50. Each process in the encoding unit 10 is controlled by a control signal from a control unit 50. Furthermore, the encoding unit 10 may be provided with additional processing in accordance with the encoding method (H.265, H.266, and the like) as appropriate.

The encoding unit 10 encodes an image as an encoding target (hereinafter, referred to as an “encoding target image”). In this embodiment, the encoding target image is a captured image acquired by an image using an imaging device mounted on a vehicle. The captured image is input to the block division determination unit 40 in the image encoding device 100. The encoding unit 10 executes the encoding process for each encoding target block specified based on the division pattern determined by the block division determination unit 40. The division pattern will be described in detail later.

The encoding unit 10 includes a subtractor 11, a transformation/quantization unit 12, a variable length encoding unit 13, an inverse quantization/inverse transformation unit 14, an adder 15, a frame buffer 16, an intra prediction unit 17, an inter prediction unit 18, and a switching unit 19. The processing by each functional unit of the encoding unit 10 is similar to the processing performed by an encoding unit that executes encoding conforming to H.265 (i.e., HEVC standard) or H.266 (i.e., VVC standard). That is, the subtractor 11 calculates the difference between the image block output from the block division determination unit 40 and the prediction image output from the switching unit 19, and generates differential image data based on this difference. The transformation/quantization unit 12 performs an orthogonal transformation on the differential image data, and executes a quantization process on the acquired transformation coefficient as a target to generate a quantized transformation coefficient. The variable length encoding unit 13 performs entropy encoding, such as arithmetic encoding, on the quantized transformation coefficient, and outputs an encoded stream. The inverse quantization and inverse transformation unit 14 inverse-quantizes the quantized transformation coefficient output from the transformation and quantization unit 12, and also performs inverse orthogonal transformation on the quantized transformation coefficient to generate an prediction residual (i.e., an prediction error). The adder 15 adds the inverse transformation data and the prediction image output from the switching unit 19 to generate a reconstruction image. The frame buffer 16 stores the reconstruction image data. The reconstruction image data is also output to the intra prediction unit 17. The intra prediction unit 17 determines an intra prediction method based on the correlation between the intra prediction data generated from pixel data surrounding the encoding target block in the reconstruction image and image data of the encoding target block. On the other hand, the inter prediction unit 18 specifies a motion vector that reduces the inter-screen difference between the reconstruction image and the reference image, and notifies the switching unit 19 of the motion vector. The switching unit 19 selects an prediction method that provides smaller differential image data based on the prediction result of the intra prediction unit 17 and the prediction result of the inter prediction unit 18.

The image acquisition unit 30 acquires the label image output by the label image generation unit 200 and passes the label image to the block division determination unit 40. The label image generation unit 200 is mounted in the same vehicle as the vehicle in which the image encoding device 100 is mounted. The label image generation unit 200 includes an image recognition unit 210 for an Advanced Driver Assistance System (i.e., ADAS). An image captured by an imaging device (not shown) is input to the ADAS image recognition unit 210. The ADAS image recognition unit 210 executes so-called semantic segmentation processing. Specifically, the ADAS image recognition unit 210 generates a label image from the input captured image using a convolutional neural network (i.e., CNN) or the like. The “label image” is an image in which a label indicating the type of each feature is assigned to a region of the image (i.e., pixel) corresponding to each feature in the image, and is also defined as the result of semantic area segmentation. The label image generated in this manner is input to the drive support control unit 300 together with the results of other recognition processes not shown, and is used for drive assistance processes such as prediction of the vehicle's own position by recognizing and determining preceding vehicles, oncoming vehicles, pedestrians, traffic signs, and the like. As will be described in detail later, in this embodiment, the label image thus generated for drive assistance is used to determine a division pattern of an encoding target block in an encoding target image. In this embodiment, the frame rate of the label image and the frame rate of the encoding target image are the same. Furthermore, the label image and the encoding target image have the same resolution and the same aspect ratio.

The block division determination unit 40 executes a division block determination process, which will be described later, to determine a division pattern of an encoding target block in an encoding target image. The control unit 50 controls each functional unit of the image encoding device 100 and cooperates with the label image generation unit 200.

### A2. Division Pattern Determination Process:

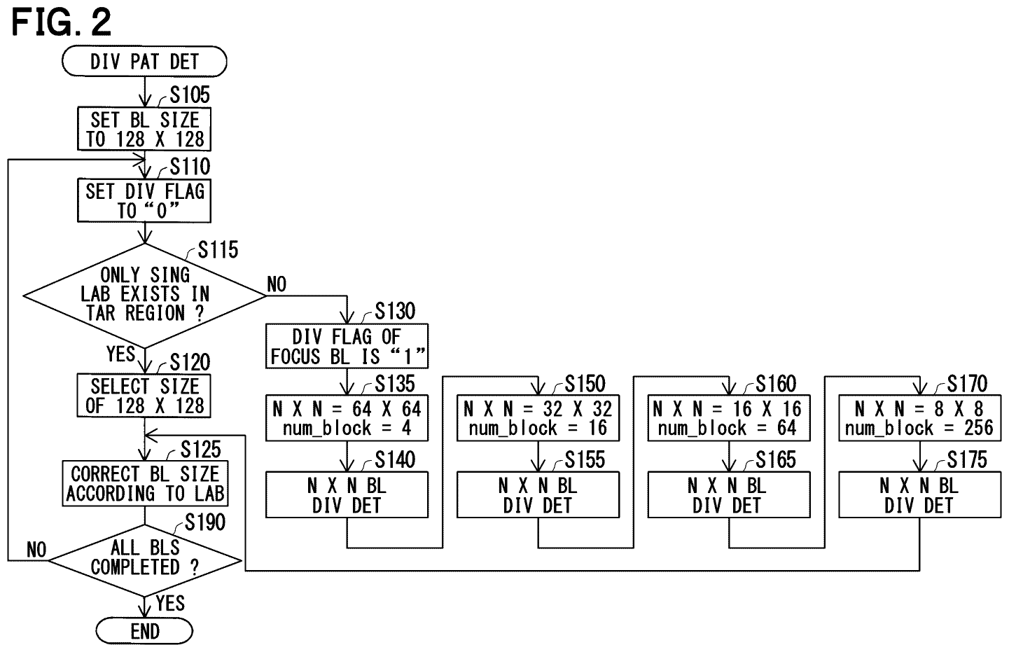

The division pattern determination process shown in FIG. 2 is a process for determining a division pattern that indicates which region of the encoding target image is to be encoded with which size of block. The block division determination unit 40 executes this division pattern determination process every time image data (i.e., frame data) of an encoding target image and a label image are input.

In step S105, the block division determination unit 40 sets the block size to 128×128. In FIG. 2, the block size starts with 128×128, alternatively, it is possible to start with an initial size depending on the encoding method. In the following, the word “step” in each procedure will be omitted and the procedure will simply be referred to as S105, and the like. In S110, the block division determination unit 40 sets the division flag to “0”. The “division flag” is a variable that indicates whether or not a target block for which a division pattern is to be determined is to be divided. The division flag “0” means “do not divide”, and the division flag “1” means “divide”. The block division determination unit 40 sequentially scans blocks of interest in the encoding target image in units of the block size determined in S105 (hereinafter referred to as the “initial block size”), and determines a division pattern in each block.

In S115, the block division determination unit 40 specifies the type of label of a region in the label image that corresponds to the block of interest as a target (hereinafter referred to as the “corresponding region”), and determines whether only a single label exists in the corresponding region.

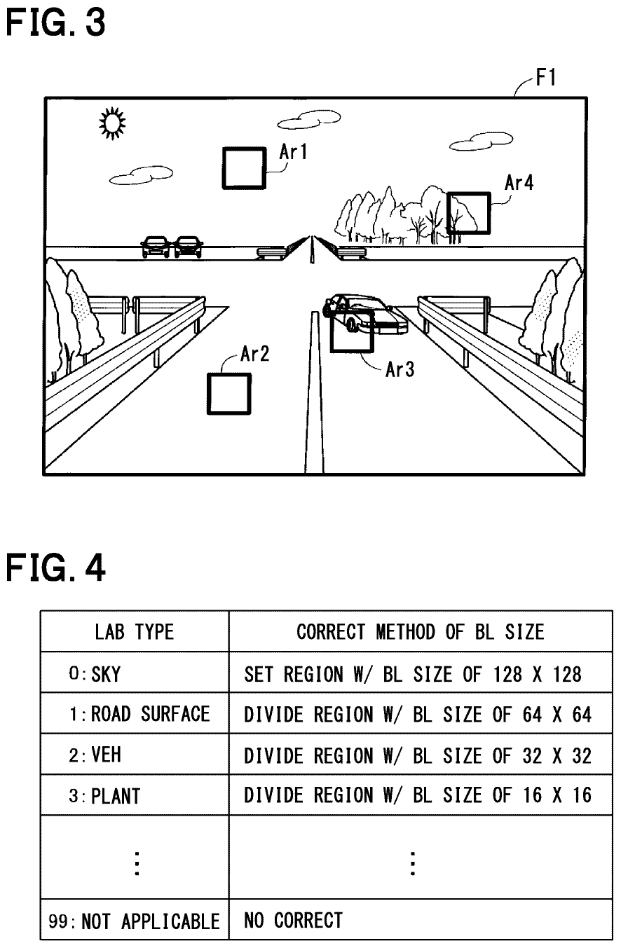

For example, in the example of FIG. 3, a first region Ar1 in an encoding target image F1 is a region that corresponds entirely to the sky. Therefore, in the region of the label image corresponding to the first region Ar1, there is only a single type of label indicating “sky”. Similarly, in the region of the label image corresponding to the second region Ar2, there is only a single type of label indicating “road”. On the other hand, in the region of the label image corresponding to the third region Ar3, a label indicating “road” and a label indicating “vehicle” exist. In addition, the region of the label image corresponding to the fourth region Ar4 also includes a label indicating “sky” and a label indicating “plant”.

In S115 shown in FIG. 2, if it is determined that only a single label exists in the corresponding region (“YES” at S115), the block division determination unit 40 selects a size of 128×128 as the provisional division size of the block of interest (at S120). Therefore, in this case, the entire block of interest is provisionally determined as one block.

In S125, the block division determination unit 40 corrects the selected (i.e., determined) block size in accordance with the type of the single label included in the block of interest. At this time, the block division determination unit 40 corrects the block size by referring to the block size correction table shown in FIG. 4. As shown in FIG. 4, the block size correction table associates label types with block size correction methods. Specifically, the correction method for “setting a region to 128×128 block size” is set in association with the label “0” indicating the sky. Further, the correction method for “dividing the region into 64×64 block sizes” is set in association with the label “1” indicating the road surface (i.e., road). The correction method for “dividing the region into 32×32 block sizes” is set in association with the label “2” indicating a vehicle. The correction method for “dividing the region into 16×16 block sizes” is set in association with the label “3” indicating the plant. Moreover, the correction method for no correction is set in association with the label “99”, which indicates that the label does not fall into any category. Generally, the “sky” corresponds to regions of low variation in an image with few edges. In this case, the encoding efficiency is improved by encoding with a larger block size. On the other hand, vehicles and plants have complex shapes and patterns that include many edges. For this reason, unless the encoding is performed using a small block size, the encoding efficiency may decrease. Therefore, in this embodiment, for a block to which a single label is assigned, the block of interest is divided so that the block size corresponds to the type of the corresponding label.

As shown in FIG. 2, in S190, the block division determination unit 40 determines whether or not division patterns have been determined for all blocks in the encoding target image. If it is determined that the division patterns have been determined for all blocks (“YES” at S190), the process ends. On the other hand, if it is determined that division patterns have not been determined for all blocks (“NO” at S190), the block of interest is moved to the next block and the process returns to S110.

In the above-described S115, if it is determined that only a single label does not exist in the corresponding region, that is, if it is determined that multiple types of labels exist in the corresponding region (“NO” at S115), the block division determination unit 40 sets the division flag of the block of interest to “1” (at S130). In S135, the block division determination unit 40 sets the block size (i.e., N×N) and the number of blocks (i.e., num_block) under the prerequisites that the block of interest (with the block size of 128×128) is to be divided into four blocks with the block size of 64×64. That is, in this case, the block size is set to “64×64” and the number of blocks is set to “4”. In the following, a block with a block size of N×N will also be simply referred to as an “N×N block.” In S140, the block division determination unit 40 determines whether or not further division is required for the total of four 64×64 blocks that are divided in S135. Thereafter, a process for determining whether or not further division of an N×N block as the target is necessary (hereinafter referred to as an “N×N block division determination process”) is repeatedly executed while changing the value of N. In S140, an N×N block division determination process is executed with “N=64”.

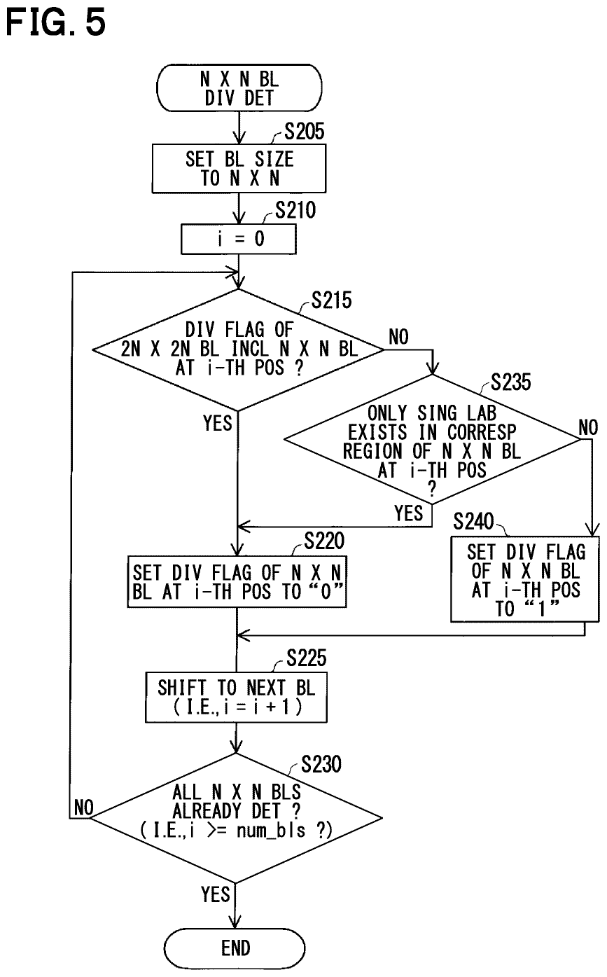

As shown in FIG. 5, in the N×N block division process, first, in S205, the block division determination unit 40 sets the block size to N×N. When N×N block division processing is executed in S140, the block size is set to 64×64 in S205. In S210, the block division determination unit 40 assigns “0” to a variable i indicating a block number. When the block size is 64×64, there are four 64×64 blocks within the original block size of 128×128 before division. In this embodiment, numbers from 0 to 3 are assigned to these four blocks.

In S215, the block division determination unit 40 determines whether the division flag of the 2N×2N block including the i-th N×N block is “0” or not. When the N×N block division process is executed in S140, the 2N×2N block is 128×128 block, and the division flag is set to “1” in S130 described above.

If it is determined in S215 that the division flag of the 2N×2N block that includes the i-th N×N block is not “0” (“NO” at S215), the block division determination unit 40 determines whether or not only a single label exists in the corresponding region of the i-th N×N block (at S235). In S235, if it is determined that there is not only a single label in the corresponding region of the i-th N×N block, i.e., if it is determined that there are multiple types of labels in the corresponding region (“NO” at S235), the block division determination unit 40 sets the division flag of the block of interest, i.e., the i-th N×N block, to “1” (at S240).

If the division flag of the 2N×2N block is “0” in the above-described S215 (“YES” at S215), or if it is determined in the above-described S235 that only a single label exists in the corresponding region of the i-th N×N block (“YES” at S235), the block division determination unit 40 sets the division flag of the i-th N×N block to “0” (at S220).

In S225, the block division determination unit 40 shifts the block of interest to the next block (i.e., the (i+1)-th block). The block division determination unit 40 determines whether or not all N×N blocks have been determined as blocks of interest (at S230). If it is determined that all N×N blocks have been determined as the block of interest (“YES” at S230), the N×N block division determination process ends. On the other hand, if it is determined that all N×N blocks have not been determined as the block of interest (“NO” at S230), the process returns to step S215. In this case, division is then determined for the (i+1)-th N×N block, and a division flag is set.

As shown in FIG. 2, in S150 after completing S140, the block division determination unit 40 sets the block size (i.e., N×N) and the number of blocks (i.e., num_block) under the prerequisites that the block of interest (with the block size of 64×64) is to be divided into four blocks with the block size of 32×32. That is, in this case, the block size is set to “32×32” and the number of blocks is set to “16”. In S155, “N=32” and an N×N block division determination process is executed.

In S160 after completing S155, the block division determination unit 40 sets the block size (i.e., N×N) and the number of blocks (i.e., num_block) under the prerequisites that the block of interest (with the block size of 32×32) is to be divided into four blocks with the block size of 16×16. That is, in this case, the block size is set to “16×16” and the number of blocks is set to “64”. In S165, an N×N block division determination process is executed with “N=16”.

In S170 after completing S165, the block division determination unit 40 sets the block size (i.e., N×N) and the number of blocks (i.e., num_block) under the prerequisites that the block of interest (with the block size of 16×16) is to be divided into four blocks with the block size of 8×8. That is, in this case, the block size is set to “8×8” and the number of blocks is set to “256”. In S175, an N×N block division determination process is executed with “N=8”. After completion of S175, S125 and S190 described above are executed.

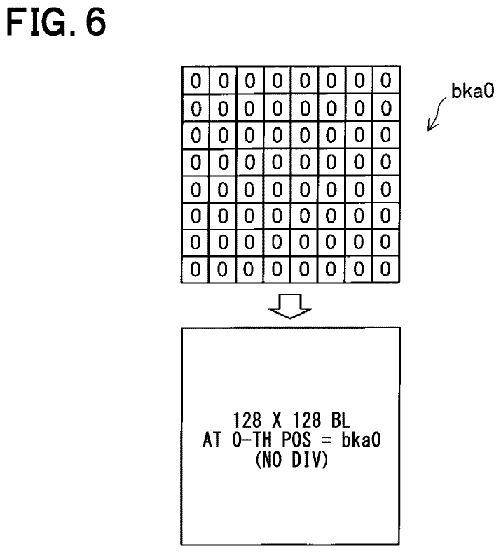

For example, as shown in FIG. 6, it is assumed that the corresponding region of the 0th 128×128 block bka0 is the first area Ar1 shown in FIG. 3. In FIG. 6, 16×16 pixels are represented as one small square. If the first region Ar1 is assigned a single label “0” for all the regions, then in S115 it is determined that only a single label exists (“YES” at S115), a size of 128×128 is provisionally determined, and in S125 the 128×128 block size (see FIG. 4) corresponding to the label “0” is selected. Furthermore, since the division flag is set to “0” in S110, when an N×N block division determination is performed for blocks of each size included in the block bka0, it is always determined in S215 that the division flag of the 2N×2N block that includes the i-th N×N block is “0” (“YES” at S215), and the division flag of “0” is set for the i-th N×N block. Therefore, the corresponding region corresponding to the block bka0 shown in FIG. 6 will not be divided any further.

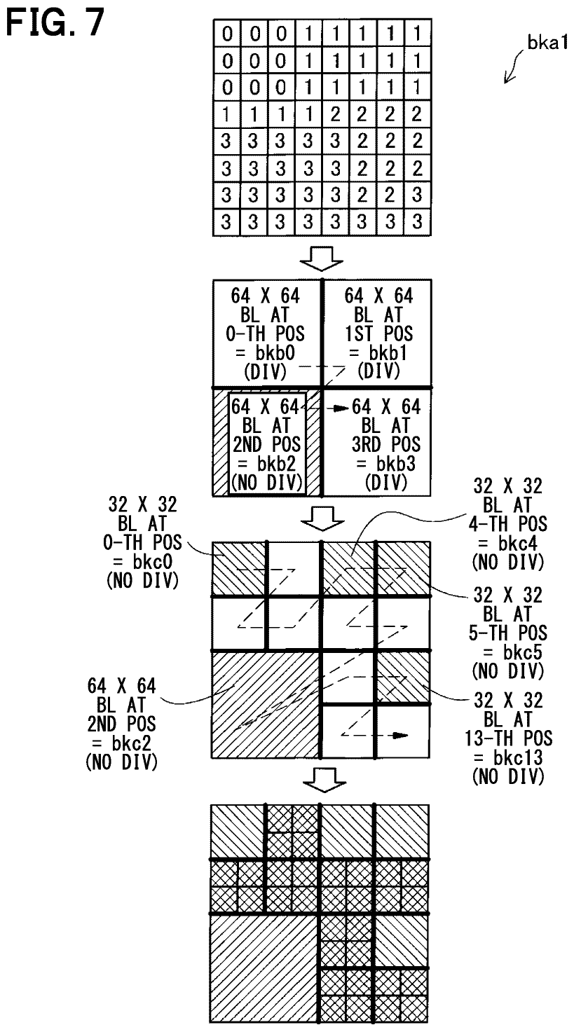

On the other hand, in the block bka1 having a block size of 128×128 shown in FIG. 7, there are four types of labels (i.e., from “0” to “3”). In FIG. 7, 16×16 pixels are represented as one small square, similarly to FIG. 6. In this case, the division flag for the block bka1 is set to “1” in S130. In S135, N×N is set to 64×64, and the number of blocks is set to “4”. In the N×N block division determination in S140, as shown in the second row from the top of FIG. 7, four 64×64 blocks are scanned in the order of upper left, upper right, lower left, and lower right, and S210 to S240 are executed for each 64×64 block. Here, in the third 64×64 block, i.e., the block bkb2, there is only a single label “3”. In this case, in S235, it is determined that only a single label exists in the corresponding region (“YES” at S235), and the division flag for the block bkb2 is set to “0”. Therefore, the division flags for the 32×32 blocks, 16×16 blocks, and 8×8 blocks included in the block bkb2 are all set to “0”, and the block bkb2 will not be divided any further.

In contrast, the block bkb0, which is the first 64×64 block, the block bkb1, which is the second 64×64 block, and the block bkb3, which is the fourth 64×64 block, have multiple types of labels. Therefore, each of the three 64×64 blocks bkb0, bkb1, and bkb3 is divided into four 32×32 blocks. In the four 32×32 blocks included in the block bkb0, the top left block bkc0 has only a single label “0”, while the other three blocks have multiple types of labels. Furthermore, in the four 32×32 blocks included in the block bkb1, the top left block bkc4 and the top right block bkc5 only have a single label “1”, while the other two blocks have multiple types of labels. In the four 32×32 blocks included in the block bkb3, the upper right block bkc13 has only a single label “1”, while the other three blocks have multiple types of labels. Therefore, as shown in the third row from the top of FIG. 7, in the 32×32 blocks, the three blocks bkc0, bkc4, bkc5, and bkc13 indicated by hatching will not be divided any further, and the other blocks will be further divided into 16×16 blocks. Finally, as shown in the bottom part of FIG. 7, the block of interest is divided into 16×16 blocks, and only a single label exists in all corresponding regions. Then, the block size is corrected and set according to the single label present in each corresponding region. When the process moves from S175 to S125, it is possible that the block size acquired by the division determination is smaller than the corrected size for each label shown in FIG. 4. In this case, the correction shown in FIG. 4 is not performed, and the block size after division can be used as it is.

The image encoding device 100 of the above described first embodiment includes a block division determination unit 40 that determines a division pattern of an encoding target block in an encoding target image based on each region in a label image and the labels assigned to the regions. Therefore, the encoding block can be properly determined while suppressing excessive consumption of resources such as a CPU and a memory for determining the division pattern of the encoding target block.

Furthermore, when there is a single type of label in the corresponding region, the block division determination unit 40 divides the block of interest according to the type of label, thereby simplifying the division determination process and it is not necessary to prepare a dedicated neural network and NPU resources for the division determination. Furthermore, if the type of label is single, an proper block size can be determined according to the label type, and therefore, according to the image encoding device of this embodiment, the corresponding region can be divided into proper encoding blocks.

Furthermore, when there are multiple types of labels in the corresponding region, the block of interest is divided regardless of the types of labels, so that it is possible to suppress a part of the corresponding region from being divided into block sizes that are inappropriate for a feature to which another type of label is attached, compared to a configuration in which the block of interest is divided according to a certain type of label out of multiple types of labels.

### B. Second Embodiment

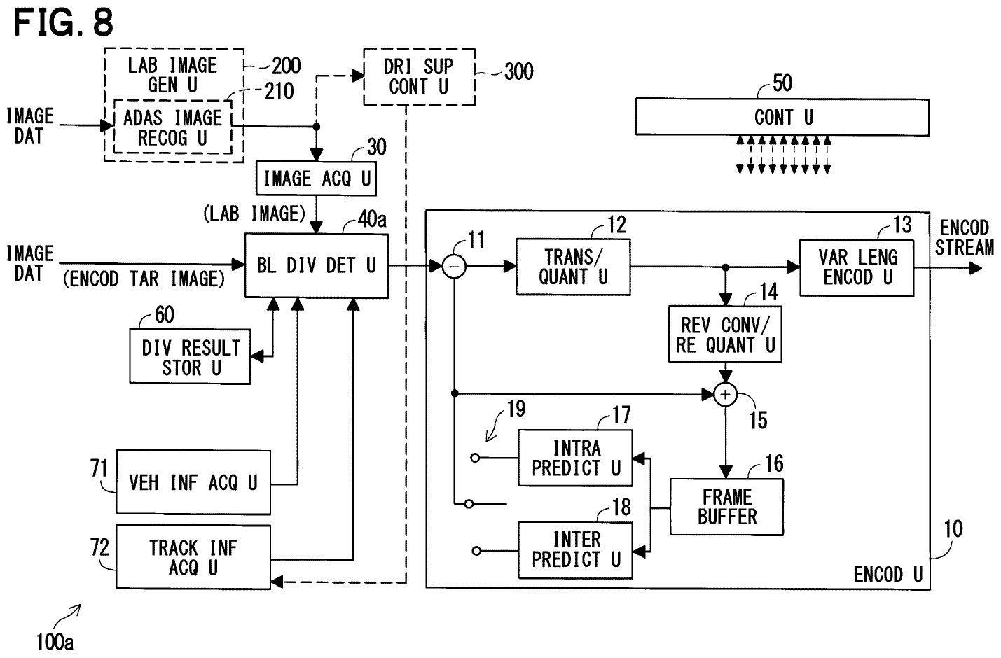

The image encoding device 100a according to the second embodiment shown in FIG. 8 differs from the image encoding device 100 according to the first embodiment in that the image encoding device 100a additionally includes a division result storage unit 60, a vehicle information acquisition unit 71, and a tracking information acquisition unit 72, and in that the image encoding device 100a includes a block division determination unit 40a instead of the block division determination unit 40. Other configurations of the image encoding device 100a of the second embodiment are the same as those of the image encoding device 100 of the first embodiment, so the same configurations are given the same reference numerals and detailed description thereof will be omitted. In the first embodiment, the frame rate of the label image and the frame rate of the encoding target image are the same. In contrast, in the second embodiment, the frame rate of the label image is lower than the frame rate of the encoding target image. For example, the frame rate of the encoding target image may be 30 fps, whereas the frame rate of the label image may be 10 fps.

The division result storage unit 60 stores the block division results (i.e., division patterns) acquired by the block division determination unit 40a.

The vehicle information acquisition unit 71 acquires information relating to the operation of the vehicle in which the image encoding device 100a is mounted (hereinafter referred to as “vehicle information”). In this embodiment, the vehicle information acquisition unit 71 acquires information regarding the operation and the behavior of the vehicle from various ECUs and SoCs mounted on the vehicle. The vehicle information may include any information that can be used to determine the vehicle's relative speed and relative position to surrounding features, such as vehicle speed, acceleration and deceleration, steering angle, vehicle yaw, pitch, roll, and gear lever information.

The tracking information acquisition unit 72 acquires tracking information of a moving object that is identified using the label image and is within the label target image. The tracking information refers to information regarding the position, the moving direction and the moving speed of a moving object. Here, the tracking information is that of a moving object acquired by semantic segmentation, alternatively, it is possible to use the tracking information of the moving object detection result by other recognition processing as the tracking information. In this embodiment, the driving support control unit 300 continuously identifies and stores the positions, the moving directions, and the moving speeds of moving objects, such as vehicles and pedestrians, identified using label images. The tracking information acquisition unit 72 acquires the tracking information from the driving support control unit 300.

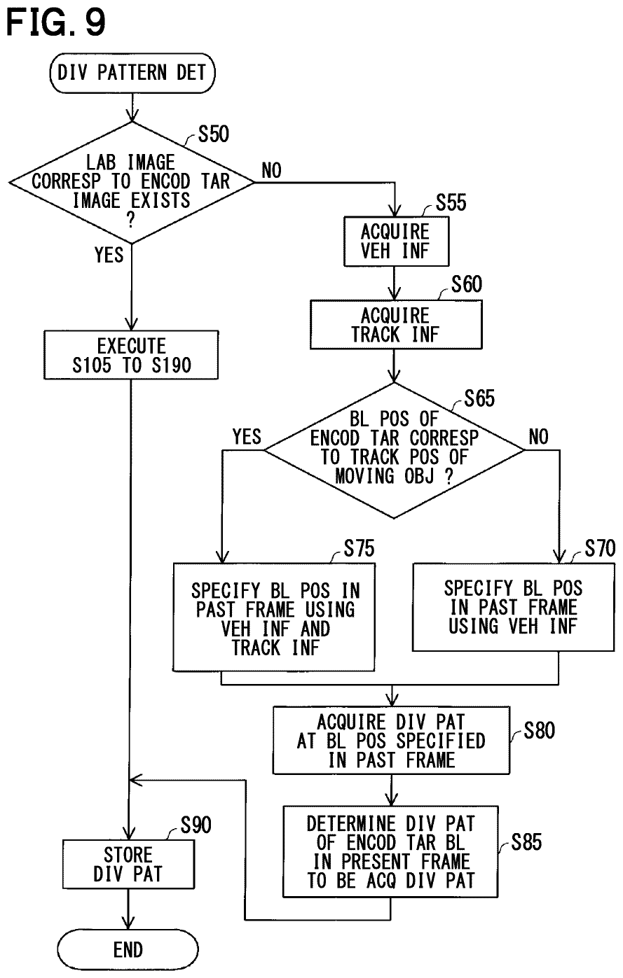

As described above, in the second embodiment, the frame rate of the label image is lower than the frame rate of the encoding target image. Therefore, when determining a division pattern for the encoding target image, a corresponding label image may not exist. Therefore, in the division pattern determination process of the second embodiment, a procedure different from that of the division pattern determination process of the first embodiment is set so that a division pattern is properly determined even when a corresponding label image does not exist. Specifically, as shown in FIG. 9, the division pattern determination process of the second embodiment differs from the division pattern determination process of the first embodiment in that the division pattern determination process of the second embodiment additionally executes S50, S55, S60, S65, S70, S75, S80, S85, and S90, but the other steps are the same.

Before the above-described steps S105 to S190 are executed, step S50 is executed. In S50, the block division determination unit 40a determines whether or not there is a label image corresponding to the encoding target image (having the same time information as the encoding target image). If it is determined that there is a label image corresponding to the encoding target image (“YES” at S50), S105 to S190 described in the first embodiment are executed.

If it is determined that there is no label image corresponding to the encoding target image (“NO” at S50), the block division unit 40a acquires the vehicle information through the vehicle information acquisition unit 71 (at S55). Furthermore, in S60, the block division unit 40a acquires the tracking information through the tracking information acquisition unit 72. In S65, the block division determination unit 40a uses the vehicle information acquired in S55 and the tracking information acquired in S60 to determine whether or not the encoding target block position corresponds to a tracking position of a moving object. In the second embodiment, the block division determination unit 40a determines a block division pattern for encoding while sequentially scanning blocks in units of 128×128, which is the initial block size in the first embodiment. Then, in S65, it is determined whether the position of the block as the encoding target block, that is, the block for which the block division pattern is to be determined, corresponds to the tracking position of the moving object. The tracking position of a moving object is acquired, for example, as follows. First, the relative position and the relative speed of the moving object with respect to the vehicle are calculated from the position and the speed of the moving object acquired from the tracking information and the position and the speed of the vehicle acquired from the vehicle information. Additionally, the amount of time that has elapsed since the vehicle information and the tracking information were acquired is specified. Then, from these relative positions and the relative speeds, and the elapsed time, the current position of the moving object is calculated as the tracking position.

If it is determined that the position of the encoding target block does not correspond to the tracking position of a moving object (or the corresponding tracking information itself cannot be used) (“NO” at S65), the block division determination unit 40a uses the vehicle information to specify the block position of the encoding target block in a past frame (at S70). When the position of the encoding target block does not correspond to the tracking position of a moving object, the position of the encoding target block corresponds to the position of a stationary body (i.e., the stationary object) different from a moving object. In this case, the current position of the stationary object should be at a position that has moved from its position in the past frame by an amount corresponding to the change in the position of the vehicle. Therefore, in S70, the vehicle information including the vehicle speed, the steering angle, and the like is used to determine the relative position and the relative speed of the stationary objects in relation to the vehicle, and the position of the encoding target block in the past frame is determined based on the prediction position and the relative speed. The “past frame” refers to a label image that was used when a division pattern was previously determined.

If it is determined that the position of the encoding target block corresponds to the tracking position of a moving object (“YES” at S65), the block division determination unit 40a uses the vehicle information and the tracking information to specify the block position of the encoding target block in the past frame (at S75). When the encoding target block position corresponds to the tracking position of a moving object, the current position of the moving object should be at a position moved from the position in the past frame at a speed relative to the vehicle. Therefore, in S75, the vehicle information including the vehicle speed, the steering angle, and the like, and the tracking information including the speed of the moving object, and the like are used to determine the relative speed and the relative position of the moving object with respect to the vehicle, and the relative speed and the relative position are used to determine the position of the encoding target block in the past frame.

After the above-described S70 or S75 is completed, the block division determination section 40a acquires the division pattern of the block position in the past frame specified in the past frame from the division result storage unit 60 (at S80). In S85, the block division determination unit 40a determines the division pattern acquired in S80 as the division pattern for the encoding target block in the current frame (i.e., in the encoding target image). After completing S85, the block division determination unit 40a stores the division pattern determined in S85 in the division result storage unit 60 together with the position information of the encoding target block (at S90). Although not shown in FIG. 9, as described above, the block division determination unit 40a repeatedly executes the above-described S50 to S90 while scanning the encoding target block in the encoding target image. Then, when the division patterns are determined for all blocks of the encoding target image and the determined division patterns are stored in the division result storage unit 60, the division pattern determination process ends.

Here, for an object that appears for the first time in the current frame, the division pattern has not been determined in the past frame. Therefore, for blocks including such objects, a block of the initial block size (i.e., 128×128 block) may be used as the division pattern, or another division pattern may be used as the initial division pattern (i.e., default pattern). As described above, in this embodiment, when a label image corresponding to the encoding target image is not acquired, the division pattern determined for the encoding target image that was acquired earlier in time than the current image is modified in accordance with the vehicle operation indicated by the vehicle information and the direction and the amount of movement of the moving object indicated by the tracking information, thereby determining the division pattern for the entire encoding target image.

The image encoding device 100a of the second embodiment described above provides the same effects as the image encoding device 100 of the first embodiment. In addition, when a label image that corresponds in time to the encoding target image is not acquired, the block division determination unit 40a determines the division pattern by modifying the division pattern determined for the encoding target image that was input in time before the current encoding target image in accordance with the vehicle operation indicated by the vehicle information. Therefore, even when a label image that corresponds in time to the encoding target image is not acquired, a proper division pattern can be determined. This is because the positions of features in the encoding target image change in accordance with the movement of the vehicle.

Furthermore, when a label image that corresponds in time to the encoding target image is not acquired, the block division determination unit 40a determines the division pattern by modifying the division pattern determined for the encoding target image that was input in time before the current encoding target image in accordance with the direction of movement and the amount of movement of the moving object indicated by the tracking information. Therefore, even when a label image that corresponds in time to the encoding target image is not acquired, a proper division pattern can be determined. This is because, when the feature is a moving object such as another vehicle or a pedestrian, the position of the moving object in the encoding target image changes in accordance with the movement of the moving object.

### C. Third Embodiment

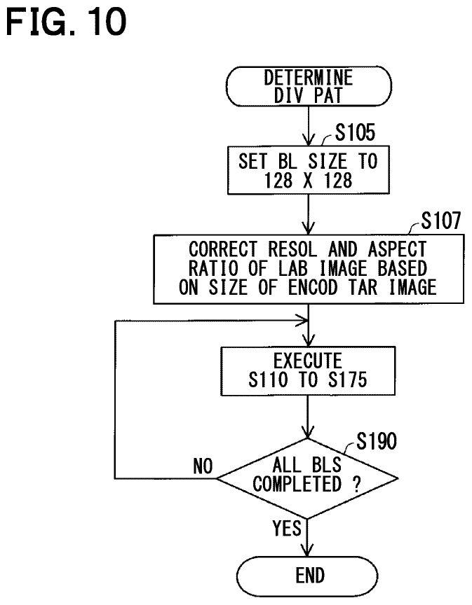

As shown in FIG. 10, the image encoding device 100 of the third embodiment differs from the image encoding device 100 of the first embodiment in that S107 is added and executed in the division pattern determination process. The device configuration of the image encoding device 100 of the third embodiment and other procedures in the division pattern determination process are the same as those of the first embodiment, so the same configurations and procedures are given the same reference symbols and detailed descriptions thereof are omitted. In FIG. 10, steps S110 to S175 are shown in a simplified form.

After completing S105, the block division determination unit 40 corrects the resolution and the aspect ratio of the label image to match the size of the encoding target image (at S107). In S107, if the encoding target image and the label image have the same resolution and the same aspect ratio, the label image is not particularly corrected. On the other hand, if the resolution and the aspect ratio of the encoding target image and the resolution and the aspect ratio of the label image are different from each other, the block division determination unit 40 corrects the resolution and the aspect ratio of the label image in S107 so that they match the resolution and the aspect ratio of the encoding target image. In this way, the image size of the label image and the image size of the encoding target image can be made the same, and the entire encoding target image can be divided into blocks in a proper division pattern. After completion of S107, the above-described S110 to S190 are executed.

The image encoding device 100 of the third embodiment described above provides the same effects as the image encoding device 100 of the first embodiment. In addition, when the resolution and the aspect ratio of the encoding target image and the resolution and the aspect ratio of the label image are different from each other, the block division determination unit 40 corrects these and then determines the block division pattern, thereby being able to more properly determine the division pattern of the encoding target block. It is also conceivable that only a part of the encoding target image is cut out to generate a label image (for example, the encoding target image is 4K2K in size, but the label image is generated only in the central 2K1K size region). In such a case, an image can be generated in S107 by padding and interpolating the region where no label image exists with a predetermined label (such as label 99 shown in FIG. 4). In this way, even if the region represented by the label image is smaller than the region represented by the encoding target image, a division pattern is determined based on the label image for the region of the encoding target image that corresponds to the label image, so that the encoding block can be determined more properly. For regions where label images are not available (i.e., padded/interpolated regions), a fixed division pattern may be uniformly assigned, or another division determination process controlled by the control unit 50 may be applied.

### D. Fourth Embodiment

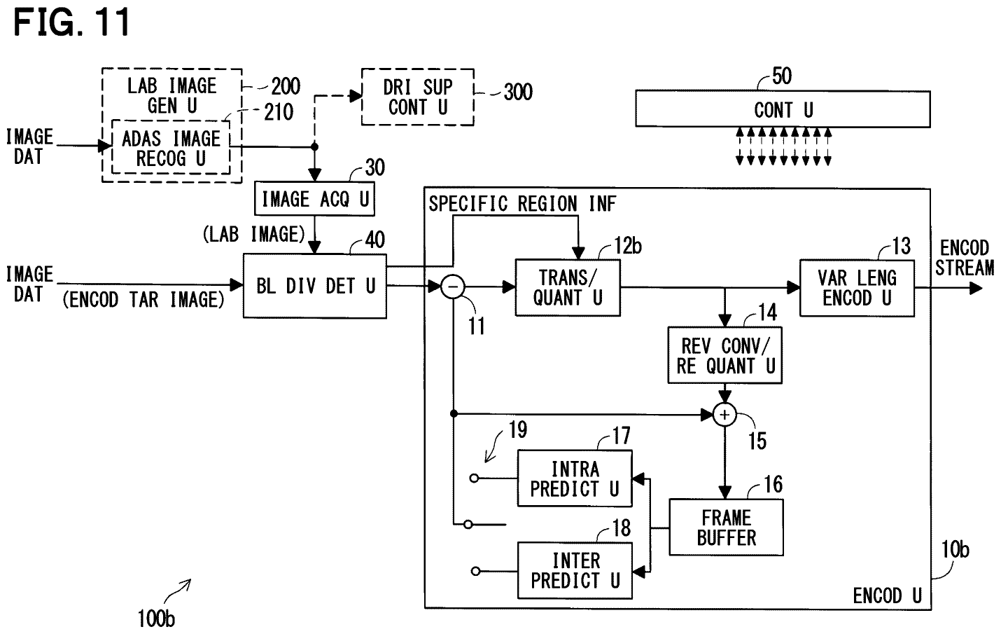

An image encoding device 100b of the fourth embodiment shown in FIG. 11 differs from the image encoding device 100 of the first embodiment in that an encoding unit 10b is provided instead of the encoding unit 10. The encoding unit 10b differs from the encoding unit 10 of the first embodiment in that a transformation/quantization unit 12b is provided instead of the transformation/quantization unit 12. In the fourth embodiment, the block division determination unit 40 transmits the specific region information to the transformation and quantization unit 12b. Other configurations of the image encoding device 100b of the fourth embodiment are the same as those of the image encoding device 100 of the first embodiment, so the same configurations are given the same reference numerals and detailed description thereof will be omitted.

The “specific region information” refers to information indicating the position and the size of a specific region. A “characteristic region” refers to a region detected based on a label image and other recognition processing results, and the characteristic region includes at least one of a predetermined character, a predetermined symbol, and a predetermined shape. Specifically, the characteristic region refers to a region including, for example, traffic signs on or along the road, license plates attached to vehicles, and the like. The block division determination unit 40 can specify a specific region in the label image received from the image acquisition unit 30, and notifies the transformation and quantization unit 12b of the specific region information regarding the specified specific region.

The transformation/quantization unit 12b corrects the quantization value for the specific region so that the quantization value is smaller than the quantization value for other regions, thereby assigning more codes to the specific region. In general, the smaller the quantization value (i.e., the larger the amount of code assigned), the more the degradation of the image caused by encoding is suppressed. The corrected quantized transformation coefficients are output to the variable length encoding unit 13 and the inverse quantization and inverse transformation unit 14.

The image encoding device 100b of the fourth embodiment described above provides the same effects as the image encoding device 100 of the first embodiment. In addition, the encoding unit 10b corrects the quantization value of blocks for specific regions, which are regions detected based on the label image and which include at least one of a predetermined character, a predetermined symbol, and a predetermined shape, to be smaller than the quantization value for other regions. Thus, it is possible to encode the specific region including at least one of these characters, symbols, and shapes to have higher image quality, thereby improving the convenience of using this information. For example, a region including a license plate can be specified as a specific area and encoded to produce high image quality for that region, thereby it is possible to accurately recognize the vehicle number from the characters on the license plate in the decoded image. In this embodiment, the information on the specific region is directly input to the transformation/quantization unit 12b. Alternatively, the equivalent processing can be achieved by inputting the information as a control signal via the control unit 50.

### E. Other Embodiments

(E1) In each embodiment, the label image generation unit 200 may be provided in the image encoding devices 100, 100a, and 100b. According to this configuration, the image encoding devices 100, 100a, and 100b themselves include a label image generation unit, so that communication for acquiring a label image can be omitted.

(E2) In each embodiment, the label image is the result of semantic region segmentation (i.e., semantic segmentation), but the present disclosure is not limited to this feature. Any image may be used as long as a label indicating the type of feature is added to a region (i.e., pixel) corresponding to each feature in the image. For example, based on a captured image or the results of object detection by a distance measurement device such as LiDAR, an image in which a moving object such as another vehicle or a pedestrian is recognized and a rectangular surrounding the moving object is shown may be used as a label image. In such an image, the rectangular information corresponds to a label indicating the type of “moving object.”

(E3) In each embodiment, the shape of the encoding block has been described as an example of a square, such as 128×128, but the shape is not limited to this feature and can be applied to any shape defined in various encoding methods.

(E4) In the division pattern determination process in each embodiment, blocks are divided until the label in the block of interest becomes a single label, up to the minimum block size of 8×8 blocks. However, the present embodiments are not limited to this feature. For example, all labels included within a 128×128 block of the initial block size may be specified, and the 128×128 block may be divided into sizes according to the most numerous types of labels. In this case, for example, the block size to be divided may be determined by referring to a block size correction table as shown in FIG. 4. Also, it may be possible to determine that a certain label is included in an amount exceeding a threshold value in a block as a determination target, and control may be performed to stop division in that case. For example, the block bkb1 in FIG. 7 includes labels 1 and 2, and in the first embodiment, the block bkb1 is described as being controlled to be further divided into blocks bkc4 to bkc7. Here, if the threshold control condition has a condition that “whether one label occupies 50% or more of the block”, then since the block bkb1 is 75% occupied by label 1, it is possible to stop the division determination in the middle of the process (i.e., the block bkb1 is determined to be a 64×64 block size). This makes it possible to control the trade-off relationship between the determination of an optimal block size and the amount of processing and the amount of determination required for that determination.

(E5) In each embodiment, the image encoding devices 100, 100a, and 100b are configured by an ECU mounted on a vehicle, but the present embodiments are not limited to this feature. It may be configured by a server device installed separately from the vehicle. Also, instead of the ECU, the image encoding device may be configured with one or more SoCs (i.e., System on Chip).

(E6) In the second embodiment, the division pattern is determined using both the vehicle information and the tracking information. Alternatively, the division pattern may be determined using only one of the vehicle information and the tracking information. For example, under the assumption that the vehicle moves at a constant speed, the division pattern may be determined using only the tracking information. Alternatively, in a scene where there are few moving objects, the division pattern may be determined using only the vehicle information.

The present disclosure may be implemented by the following embodiments. For example, the present disclosure can be realized in the form of an image encoding method, an image encoding device, a computer program for implementing the image encoding method, a non-transitory storage medium on which such a computer program is stored, and the like.

The present disclosure should not be limited to the embodiments described above, and various other embodiments may be implemented without departing from the scope of the present disclosure. For example, the technical features in the embodiment corresponding to the technical features in the form described in the summary may be used to solve some or all of the above-described problems, or to provide one of the above-described effects. In order to achieve a part or all, replacement or combination can be appropriately performed. Also, some of the technical features may be omitted as appropriate. The present disclosure may be realized, for example, in the following forms.

### [Feature 1]

An image encoding device includes: at least one of (i) a circuit and (ii) a processor having a memory storing computer program code. The at least one of the circuit and the processor having the memory is configured to cause the image encoding device to provide at least one of:
an image acquisition unit that acquires a label image in which a label representing a type of a feature is assigned to a region of the label image corresponding to the feature in a label target image;
a block division determination unit that determines a division pattern of an encoding target block in an encoding target image based on the region in the label image and the label assigned to the region; and
an encoding unit that executes an encoding process for the encoding target block specified by the division pattern as an encoding unit.

### [Feature 2]

The image encoding device according to feature 1, further includes: a label image generation unit that generates the label image by assigning the label to the region corresponding to the feature according to a feature amount extracted from the label target image.

### [Feature 3]

In the image encoding device according to feature 1 or 2, the block division determination unit is configured to specify a type of the label in a corresponding region of the label image which corresponds to a block of interest as a target in the encoding target image; and divide the block of interest according to the type of the label when the type of the label in the corresponding region is single.

### [Feature 4]

In the image encoding device according to feature 3, the block division determination unit divides the block of interest without depending on the type of the label when the type of the label in the corresponding region includes a plurality of features.

### [Feature 5]

In the image encoding device according to any one of features 1 to 4, the image encoding device further includes a vehicle information acquisition unit that is mounted on a vehicle and acquires vehicle information that is information related to an operation of the vehicle. A plurality of images are input in time series to the image encoding device as the encoding target images. The image acquisition unit acquires the label image in time series. The block division determination unit determines the division pattern by correcting a past division pattern, which was determined for a past encoding target image input in time before the encoding target image, in accordance with the operation of the vehicle indicated by the vehicle information when the label image corresponding in time to the encoding target image is not acquired.

### [Feature 6]

In the image encoding device according to any one of features 1 to 5, the image encoding device further includes a tracking information acquisition unit that is mounted on a vehicle and acquires tracking information of a moving object in the label target image specified by using the label image. A plurality of images are input in time series to the image encoding device as the encoding target images. The image acquisition unit acquires the label image in time series. The block division determination unit determines the division pattern by correcting a past division pattern, which was determined for a past encoding target image input in time before the encoding target image, in accordance with a moving direction and a moving amount of the moving object indicated by the tracking information when the label image corresponding in time to the encoding target image is not acquired.

### [Feature 7]

In the image encoding device according to any one of features 1 to 7, the encoding unit corrects a quantization value of a block in a specific region to be smaller than a block in other regions. The specific area is an area detected based on the label image and includes at least one of a predetermined character, a predetermined symbol, and a predetermined shape.

### [Feature 8]

In the image encoding device according to any one of features 1 to 8, the block division determination unit performs determination of the division pattern based on the label image only for a region of the encoding target image that corresponds to the label image when a region represented by the label image is narrower than a region represented by the encoding target image.

### [Feature 9]

In the image encoding device according to any one of features 1 to 8, the block division determination unit corrects a resolution and an aspect ratio of the label image to match a resolution and an aspect ratio of the encoding target image when the resolution and the aspect ratio of the encoding target image are different from the resolution and the aspect ratio of the label image, respectively.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause an image encoding device to perform functions” should be understood that (i) only the circuit can cause the image encoding device to perform all the functions, (ii) only the processor can cause the image encoding device to perform all the functions, or (iii) the circuit can cause the image encoding device to perform at least one of the functions and the processor can cause the image encoding device to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S105. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An image encoding device comprising:
an image acquisition unit that acquires a label image in which a label representing a type of a feature is assigned to a region of the label image corresponding to the feature in a label target image;
a block division determination unit that determines a division pattern of an encoding target block in an encoding target image based on the region in the label image and the label assigned to the region; and
an encoding unit that executes an encoding process for the encoding target block specified by the division pattern as an encoding unit.

2. The image encoding device according to claim 1, further comprising:
a label image generation unit that generates the label image by assigning the label to the region corresponding to the feature according to a feature amount extracted from the label target image.

3. The image encoding device according to claim 1, wherein:
the block division determination unit is configured to specify a type of the label in a corresponding region of the label image which corresponds to a block of interest as a target in the encoding target image; and the block division determination unit is configured to divide the block of interest according to the type of the label when the type of the label in the corresponding region is single.

4. The image encoding device according to claim 3, wherein:
the block division determination unit divides the block of interest without depending on the type of the label when the type of the label in the corresponding region includes a plurality of features.

5. The image encoding device according to claim 1, further comprising:
a vehicle information acquisition unit that is mounted on a vehicle and acquires vehicle information that is information related to an operation of the vehicle, wherein:
a plurality of images are input in time series to the image encoding device as the encoding target image;
the image acquisition unit acquires the label image in time series; and
the block division determination unit determines the division pattern by correcting a past division pattern, which was determined for a past encoding target image input in time before the encoding target image, in accordance with the operation of the vehicle indicated by the vehicle information when the label image corresponding in time to the encoding target image is not acquired.

6. The image encoding device according to claim 1, further comprising:
a tracking information acquisition unit that is mounted on a vehicle and acquires tracking information of a moving object in the label target image specified by using the label image, wherein:
a plurality of images are input in time series to the image encoding device as the encoding target image;
the image acquisition unit acquires the label image in time series; and
the block division determination unit determines the division pattern by correcting a past division pattern, which was determined for a past encoding target image input in time before the encoding target image, in accordance with a moving direction and a moving amount of the moving object indicated by the tracking information when the label image corresponding in time to the encoding target image is not acquired.

7. The image encoding device according to claim 1, wherein:
the encoding unit corrects a quantization value of a block in a specific region to be smaller than a block in other regions; and
the specific region is a region detected based on the label image and includes at least one of a predetermined character, a predetermined symbol, and a predetermined shape.

8. The image encoding device according to claim 1, wherein:
the block division determination unit performs determination of the division pattern based on the label image only for a region of the encoding target image that corresponds to the label image when a region represented by the label image is narrower than the region represented by the encoding target image.

9. The image encoding device according to claim 1, wherein:
the block division determination unit corrects a resolution and an aspect ratio of the label image to match a resolution and an aspect ratio of the encoding target image when the resolution and the aspect ratio of the encoding target image are different from the resolution and the aspect ratio of the label image, respectively.

10. The image encoding device according to claim 1, further comprising:
at least one of (i) a circuit and (ii) a processor having a memory storing computer program code,
wherein the at least one of the circuit and the processor having the memory is configured to cause the image encoding device to provide at least one of: the image acquisition unit; the block division determination unit; and the encoding unit.
